(19) United States
(12) Patent Application Publication
(10) Pub. No.: US 2014/0334245 A1
(43) Pub. Date: Nov. 13, 2014

(54) EMULSIFYING ARRANGEMENT

(71) Applicant: Karlsruher Institut fuer Technologie, Karlsruhe (DE)

(72) Inventors: Andreas Hensel, Karlsruhe (DE); Manfred Kraut, Linkenheim-Hochstetten (DE)

(21) Appl. No.: 13/890,197

(22) Filed: May 8, 2013

(51) Int. Cl. B01F 3/08

(52) U.S. Cl. CPC B01F 3/0807
USPC 366/145; 366/167.1

(57) ABSTRACT

In an emulsifying arrangement comprising a tubular emulsifying chamber with two end areas for a spiral flow with a spiral flow direction, at least one inlet for conducting two non-mixable fluid fractions into the emulsifying chamber at the first end area and at least one outlet for conducting the fluid mixture out of the emulsification chamber at the second end area wherein the emulsifying chamber has between the two end areas a cross-section which is symmetrical around an axis of symmetry and is provided with at least one curved area disturbing the spiral flow through the tubular chamber.

### BACKGROUND OF THE INVENTION

The invention concerns an emulsifying arrangement with an emulsifying chamber having inlets and outlets for a fluid mixture consisting of at least two fluid fractions or, respectively, an emulsion to be mixed or to be dispersed.

An emulsifying arrangement is used for the mixing of at least two fluid flows which are not soluble in one another or only to a limited extent in order to form an emulsion. An emulsion is a finely distributed disperse mixture of at least two fluidic phases. Herein at least one of the phases is bound, while forming droplets, as a disperse phase into a common carrier phase forming a common coherent matrix. This forms a disperse phase in a carrier phase mixture. Classic examples are oil-in-water or water-in-oil emulsions. An emulsion is considered to practically be stable over a certain period, that is, it dissociates only slowly.

Non-soluble fluid phases have an interface tension which must be overcome for introducing energy into the fluid mixture. The interface tension increases with decreasing droplet size of the disperse phase, that is in an emulsifying arrangement with constant energy input, for example an agitator vessel, the droplet size in the carrier phase the droplet size is reduced until an equilibrium is established on the basis of the increasing interface energy.

Consequently, the droplet size in the emulsion can be varied by the amount of energy input into the emulsifying arrangement. In this way, an emulsifying arrangement is different from a dispersing arrangement in which a solid material component part of changeable particle size is mixed into a liquid. Emulsifiers, preferably tensides, are mixed into the liquid phase. They assist an emulsifying process and stabilize the emulsion in that they reduce the interface tensions of the disperse phases relative to the carrier phase.

Known emulsifying arrangements utilize agitators by which the fluid mixture is not only mixed but additionally large sheer impulses are applied in a homogenous manner.

A first basic form of an emulsifying arrangement including a container arrangement with an agitator is disclosed for example in DE 348 667.

DE 23 39 530 discloses a more up-to-date mixer development with an agitator device including several serially arranged agitator blades and an outlet at the last chamber for a continuous mixing an emulsifying of a mixture comprising several components.

However, agitator devices include agitator arms, blades and other movable parts disposed in the mixing areas. Movable parts are not only subject to wear but they are basically also a source of undesired contamination. In addition, the possibilities for miniaturization and also covering all volume areas of the mixing chambers are limited.

EP 0 545 334 B1 discloses an example of an emulsifying arrangement for a continuous emulsifying arrangement for a continuous emulsifying of Diesel fuel and water which does not include any movable parts. The emulsions are formed in several stages in turbulence chambers which are in communication via nozzles and bores, wherein a rapid change between pressurizing and depressurizing promotes the emulsifying process.

Turbulence chambers, in particular in cooperation with nozzles provide for high and therefore advantageous shearing loads in the emulsion being formed but they increase the probability for larger and therefore disadvantageous residence time differences of the emulsion components in the emulsifying arrangement.

EP 2 123 349 discloses a continuous emulsifying arrangement for at least two fluid fractions which are not mixable and wherein such back-mixing is avoided. It is proposed to introduce a first fluid tangentially and a second fluid axially into a round mixing chamber. In the mixing chamber, the first fluid flows around the second fluid generating a shearing action between the two fluids. In the process, the fluid mixture begins to emulsify and is conducted as axially rotating emulsion strand to an axial outlet in which it is further emulsified.

However, in the last-mentioned emulsifying arrangement the largest energy input for forming an emulsion occurs at the beginning of the procedure that is, with the first engagement between the fluid fractions. There is a rapid initial emulsification whereas in the following sections in which a further droplet size reduction should take place there are small speed differences and consequently small energy inputs are generated between the fluid fractions. But it is exactly the further emulsifying stages where a high energy input would be important if the particle sizes in the emulsion are to be further reduced. However, the impulses generated by shearing and consequently the energy input continuously decrease.

Furthermore, the last mentioned arrangement requires for each fluid fraction an input line leading directly into the mixing chamber which could curb a parallel arrangement of a multitude of emulsifying arrangement of a multitude of emulsifying arrangement for capacity expansion.

Based hereon, it is the object of the present invention to provide a continuous emulsifying arrangement of the type referred to initially which however does not have the disadvantages and limitations mentioned above, which has no movable parts, and which avoids back-mixing and furthermore is based on a simplified design.

### SUMMARY OF THE INVENTION

For solving the object, an emulsifying arrangement with at least one tubular emulsifying chamber with two end sections is proposed. It is provided with a number of inlets for at least two dispersing fluid fractions with in each case at least one inlet into the emulsifying chamber and at least one outlet from the emulsifying chamber. Preferably all inlets are arranged exclusively in one of the end areas whereas the outlets are preferably arranged in the other end area and between the inlets and the outlets the tubular emulsifying chamber is provided with at least one curved area.

The inlets are treated technically as at least one inlet for a fluid mixture of two non-mixable fluid fractions which includes an introduction of fluid via separate as well as common inlets.

If more than one inlet as provided for, the inlets for the fluid fractions are preferably distributed over the circumference of the emulsifying chamber, that is, not at the front face, but in alternating order and in one or several planes.

The emulsifying chamber includes between the two end areas a cross-section which is symmetrical about an axis of symmetry. Inlets and/or outlets extend preferably skewed with respect to the axis of symmetry. They extend preferably in the flow direction tangentially or at an acute angle with respect to the tube wall area around the wall area surrounding directly the area where they are connected to the emulsifying chamber. In the emulsifying chamber in this way a spiral flow is formed between the inlet and the outlet with a spiral shaped flow direction around the axis of symmetry.

It is essential that the axis of symmetry and the emulsifying chamber have at least one curved area. While the spiral flow is subjected in a straight emulsifying chamber to a constant centrifugal force component which is oriented radially away from the axis of symmetry, the spiral flow in a curved chamber is subjected to a centrifugal force which extends radially outwardly from the center point of curvature of the tubular emulsifying chamber. The two centrifugal forces are combined, that is, added. The flow volume components in the spiral flow are subjected in the curved flow not only alone to the constant centrifugal force but also, by the superimposed centrifugal force resulting from the curvature to a cyclically changing force input. In this way, in an advantageous manner, a cyclical change between a compression and decompression is generated in the fluid flow which introduces pulsed energy into the fluid mixture. This dynamics does not only advantageously cause a speed-up of the emulsifying process but also improves the chances of obtaining smaller droplet sizes in comparison with not curved, straight-line emulsifying chamber.

A possible embodiment of the emulsifying arrangement is characterized in that the axis of symmetry is spiral-shaped. In this way, curved emulsifying chamber sections of increased length and consequently a longer effectiveness of pulsed energy input to the fluid mixture can be realized. In particular with such an arrangement also longer curved emulsifying chamber sections with small radii of curvature can be realized. The centrifugal force components resulting from the curvature increase with decreasing radius of curvature, that is smaller radii of curvature result advantageously in an increased amplitude of the energy input to the volume components of the spiral flow and consequently the effect and the speed of the emulsifying process.

A further embodiment of the emulsifying arrangement is characterized in that the axis of symmetry of subsequent curved sections is oriented in different space directions and/or the cross-section of the emulsifying chamber changes continuously or preferably in an abrupt manner along the line of symmetry. This measure provides for additional impulses. A change in direction additionally results in energy inputs in additional directions and consequently in disturbances in the cyclically effective centrifugal forces in their fluid flow. In this way, not only an advantageous process acceleration is achieved but also established emulsifying processes are interrupted and, by the change in direction, the miniaturization of the droplets in the emulsion is advanced.

For forming a stable spiral flow which remains in place also with regard to the curvature-caused force effects, it is advantageous if, in addition to the form of the above-mentioned inlet and outlet structures, the cross-section of the emulsifying chamber extends around the axis of symmetry in a rotationally symmetric manner. Preferably, the emulsifying chamber has a round elliptical, rectangular or square cross-section.

Basically, the cross-section of an emulsifying chamber is round. The cross-section corresponds to the extension of the spiral-shaped flow minus a boundary layer at the emulsifying chamber wall. As a result of the centrifugal force components, which are directed constantly radially outwardly from the axis of symmetry, the spiral-like flow is particularly stable. In addition, in particular a circular cross-section can be produced with simple preferably standardized means, for example, by galvanic deposited rod shaped bodies. The round material preferably consists of electrically conductive, coated plastic because it can easily be removed thermally or chemically.

An elliptical cross-section of the emulsifying chamber is advantageous in connection with a spiral flow formed in adaptation to the cross-section of the emulsifying chamber. With the elliptical chamber shape alone a cyclically increasing centrifugal force is effective on the fluid mixture (also without curvature). Basically, the effect is comparable with the centrifugal force effective on the flow by the curvature. The frequency of the swelling force is twice as large as a result of the elliptical shape (two maxima at a 360° pass of the spinal flow in the ellipse). Together with a curvature the forces effective on the flow are added vectorally and also the advantageous effects thereof. With the dynamics generated hereby the emulsifying process is in this manner accelerated and the obtainable droplet size is further reduced.

A cross-section with corners, preferably a rectangular or square cross-section of the emulsifying chamber provide in an advantageous manner for an improved manufacturing capability, preferably in a foil stack design as established by micro-process engineering. Preferably, the emulsifying chamber extends as planar structure in at least one plane, each being formed preferably by foils. The emulsifying chambers and other fluid guides are technically formed by grooves or openings in the foil stacks. The inlets and outlets extend preferably also parallel or normal to the planes wherein the axis of symmetry is disposed on, or parallel to, a plane. An integration as a component in micro-engineering arrangements is particularly advantageous with this form. The spiral flow is not guided by the carrier cross-section but is only delimited. They are formed in a free core area of the cross-section preferably as a rounded or elliptical flow, whereas the corner areas cross-sections become passive dead areas with little flow activity.

Embodiments may also be provided which have emulsifying chamber temperature control means. If the emulsifying chamber is an integral part of a micro-engineering arrangement the temperature control arrangement comprises preferably a micro-channel structure through which a cooling or heating medium flows.

It is further preferred if in the emulsifier chamber a core extending over the full length thereof is arranged. The core may be arranged so as to extend along and around the axis of symmetry in a rotationally symmetric form. The fluid volume of the emulsifying chamber is reduced thereby to an annular gap volume between the core and the inner wall of the emulsifying chamber. This embodiment has the additional advantage of providing additional solid walls by which the spiral-shaped flow is delimited by boundary layers which are formed along the walls and provide for additional shear effects in the spiral flow.

The process of repeated compression and expansion in the spiral flow which enhances the emulsifying is improved with the above mentioned core in that the annular gap volume has angle-dependent (starting from the line of symmetry) dimension differences in the open width and the spiral flow has corresponding angle-dependent cross-section increases or reductions. These dimensional differences are realized by arranging the core either eccentrically with respect to symmetry or that they are provided with axial disruptive structures such as cutouts, grooves, flat areas or steps while otherwise the core has a preferably round rotation-symmetric cross-section.

Optional embodiments provide an emulsifying chamber with a cross-section which changes along the axis of symmetry and which cause backup pressures or pressure wherein in the spiral flow.

The invention as well as details thereof will become more readily apparent from the following description of exemplary embodiments thereof with reference to the accompanying drawings.

### BRIEF DESCRIPTION OF THE DRAWINGS

FIG. 1 shows in a perspective representation an emulsifying chamber of a first embodiment with in- and outlets for explanation of the principle of the invention,

FIGS. 2a and 2b are a perspective view and respectively a cross-sectional view of a technical embodiment of the concept shown in FIG. 1,

FIGS. 3a to 3c show additional embodiments, each in a perspective view, and

FIGS. 4a and 4b show a further embodiment of a layered design.

### DESCRIPTION OF EXEMPLARY EMBODIMENTS

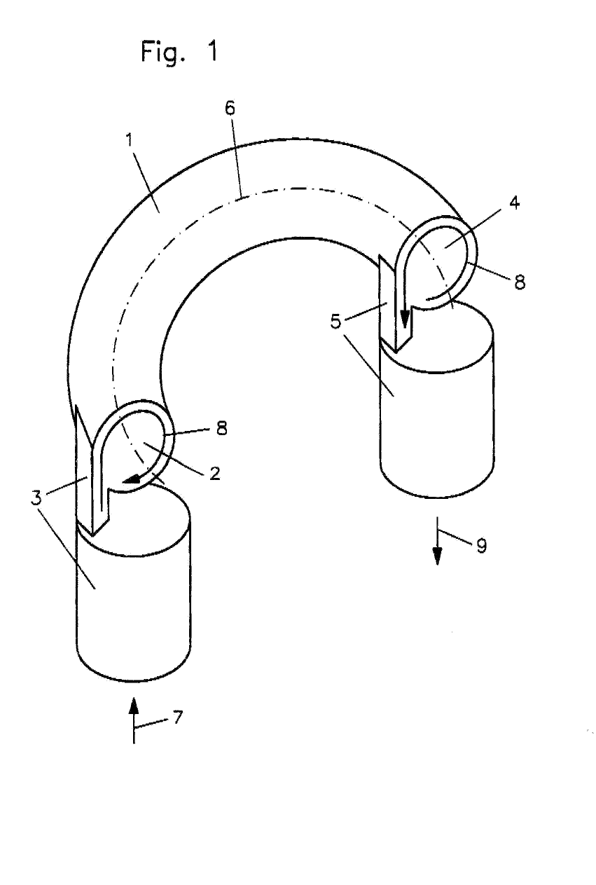

The first embodiment according to FIG. 1 shows schematically a tubular emulsifying chamber 1 with a first end area 2 provided with an inlet 3 and a second end area 4 provided with an outlet 5, and an axis of symmetry 6. A fluid mixture flow 7 enters the emulsifying chamber via the inlet and forms in the chamber a spiral flow 8 around the axis of symmetry in the direction toward the outlet. The spiral flow extends over the whole emulsifying chamber between the two end areas 2 and 4. Between the two end areas 2 and 4 the emulsifying chamber has a cross-section which is symmetrical around an axis of symmetry. With increasing travel distance in the emulsifying chamber the emulsifying process, by the effects of a pulsating and at the same time its direction changing force, causes an increasing conversion of the material mixture to an emulsion which then leaves the emulsifying chamber as an emulsion flow 9 via the outlet. As mentioned above the curved orientation as well as the fluid forces effective in the flow cause the mentioned pulsating force and also the changes of the direction of the force.

The main inlet flow direction of the fluid mixture flow 7 into the emulsifying chamber is preferably along a smooth part without a kink or deflection tangentially in the main flow direction of the spiral flow 8. Herein the flow direction of the spiral flow in the emulsifying chamber is determined or affected.

Also, the exit 4 for emulsion flow extends preferably tangentially to the main flow direction of the spiral flow 8 at the end area. Following these design criteria, the inlet and the outlet join the wall of the emulsifying chamber tangentially or at an acute angle.

The tangential orientation of the inlets and outlet with regard to spiral flow with as little as possible flow deflection provides for a laminar inlet and outlet of the fluid flow into or, respectively, out of, the emulsifying chamber. This measure ensures primarily a buildup and a stabilization of the spiral flow at the two end areas. This guide effect may be even improved by providing the end areas with a rotationally symmetrical core (annular gap area only in the end areas), which narrows down away from the end areas and ends with a tip. The emulsifying process is affected by a laminar inlet and outlet flow only indirectly by the generation of the stable spiral flow in the curved areas of the emulsifying chamber.

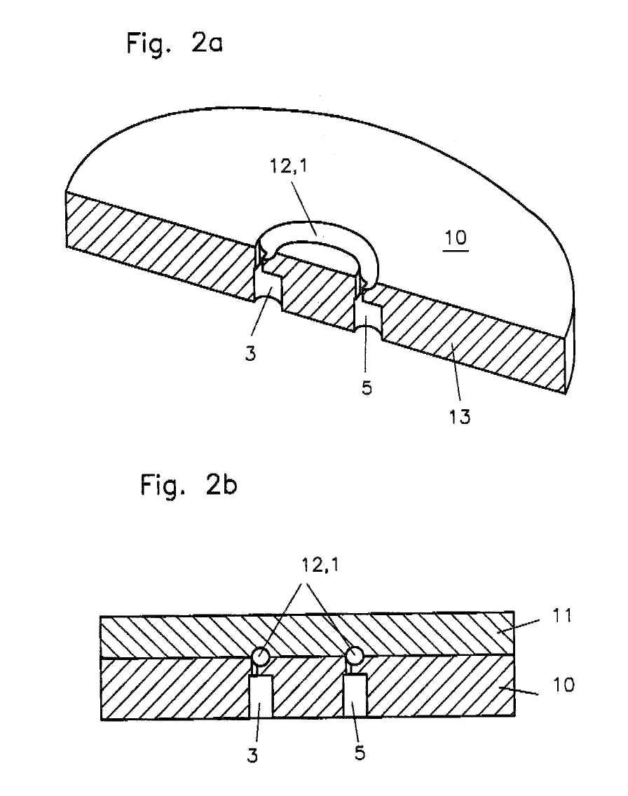

FIGS. 2a and 2b show in a perspective view and a cross-sectional view a technical implementation of the embodiment of FIG. 1.

Starting with two round discs (lower disc 10, upper disc 11), a groove 12, each preferably with a semicircular cross-section, is cut into each disc so that by placing the disc on one another a hollow space with circular cross-section is formed between the discs 10, 11 (FIG. 26). The inlet 3 and the outlet 5 are, in accordance with the mentioned design criteria, preferably drilled (round channel area) and/or formed by electoerosion (cornered channel area) into the lower disc 10. Upon placement of the two discs on top of one another and joining them by for example clamping, cementing, diffusion welding or another material- or force locking joining procedure as shown in FIG. 2, the disc compound is cut into two halves at the level of the inlet and outlet openings (see FIG. 2a). In this way, two half-disc compounds or formed which then are covered at the front along the cutting plane 13 (see FIG. 2a) by a cover foil.

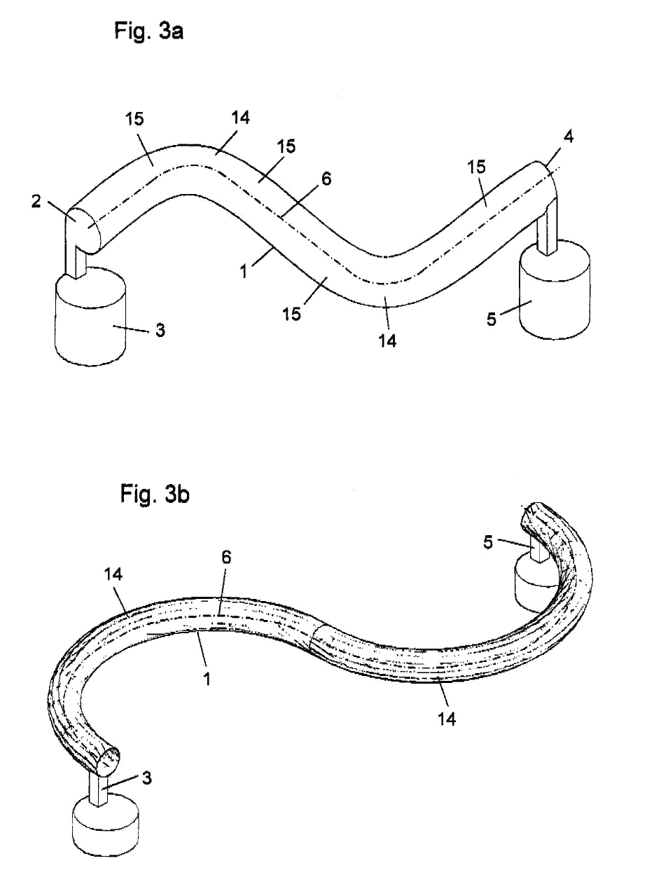

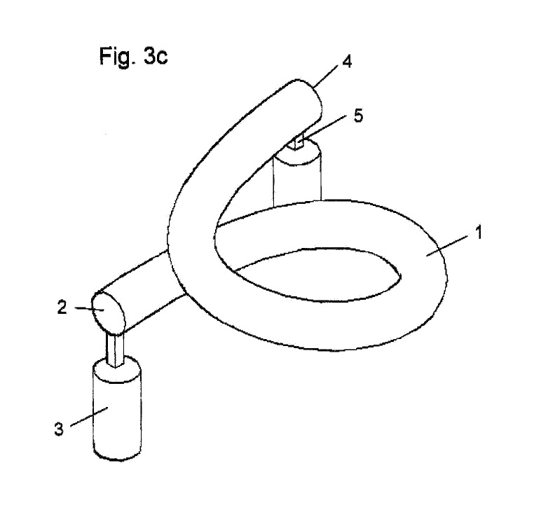

FIGS. 3a-3c show in perspective views schematically other embodiments. FIGS. 3a and 3b disclose for example an emulsifying arrangement wherein the axis of symmetry has subsequent curvatures 14 in different spatial directions. In the embodiment shown in FIG. 3a, the curved areas are joined by areas with larger transition radii 15 than in the arrangement as shown in FIG. 3b. Hereby there is a continuous change of the curvature radius that is the admission stretches in the emulsifying chamber, which additionally stabilize the spiral flow before entering a curved section. The curved sections comprise only the curves 14 with inlet and outlet areas FIG. 3c shows an emulsifying arrangement wherein the axis of symmetry extends spirally. The arrangement permits the realization of longer curved areas also with small, radius.

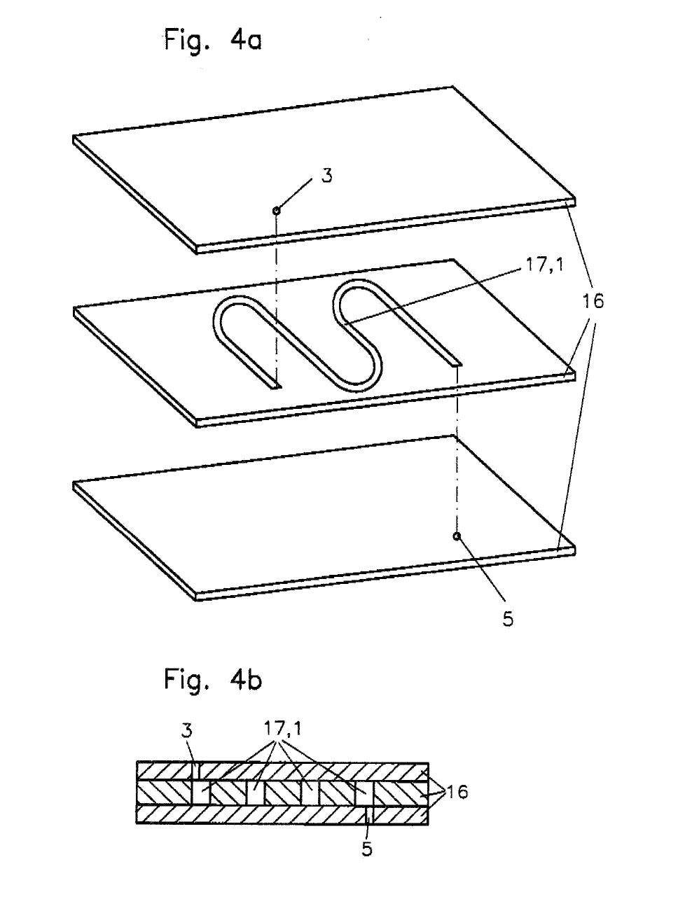

An exemplary embodiment in layer construction with stacked structured individual foils 16 is shown in FIGS. 4a and 4b. The emulsifying chamber 1 is realized in the foil in the form of a slot-shaped cutout 17, which is covered at both sides by adjacent foils. The adjacent foils themselves have openings forming an inlet 3 and an outlet 5. The cross-section of the emulsifying chamber 1 is rectangular (See sectional view FIG. 4). The foils are joined by known procedures such as preferably cementing or diffusion welding.

Reference Numerals

| | |
|---|---|
| 1 | Emulsifying chamber |
| 2 | First end area |
| 3 | Inlet |
| 4 | Second end area |
| 5 | Outlet |
| 6 | Axis of symmetry |
| 7 | Fluid mixture flow |
| 8 | Spiral flow |
| 9 | Emulsion flow |
| 10 | Lower disc |
| 11 | Upper disc |
| 12 | Groove |
| 13 | Cutting surface |
| 14 | Curvature |
| 15 | Transition radius |
| 16 | Individual foil |
| 17 | opening |

What is claimed is:

1. An emulsifying arrangement comprising:
a) a tubular emulsifying chamber (1) with a tube wall and first and second end areas (2, 4) for forming a spiral flow (8) with a spiral flow direction,
b) at least one inlet (3) for a directing fluid mixture comprising two fluid fractions which are not mixable into the emulsifying chamber at the first end area (2) and
c) at least one outlet (5) for the fluid mixture from the emulsifying chamber at the second end area (4), wherein
d) the emulsifying chamber (1) has between the two end areas (2, 4) a symmetrical cross-section around the axis of symmetry (6), wherein the outlet (5) and the inlet (3) joint the surrounding wall area tangentially in the flow direction or at an acute angle, and
e) the axis of symmetry (6) and the emulsifying chamber have at least one curved area.

2. The emulsifying arrangement according to claim 1, wherein the inlet (3) and outlets (5) extend skewed with respect to the axis of symmetry (6).

3. The emulsifying arrangement according to claim 1, wherein the cross-section of the emulsifying chamber (1) is rotation-symmetrical about the axis of symmetry.

4. The emulsifying arrangement according to claim 1, wherein the emulsifying chamber (1) has an elliptical cross-section.

5. The emulsifying arrangement according to claim 1, wherein the cross-section of the emulsifying chamber (1) is rectangular or square.

6. The emulsifying arrangement according to claim 5, wherein the emulsifying chamber (1), the inlets (3) and the outlets (5) are arranged in planes wherein the axis of symmetry is arranged on, or parallel to a plane.

7. The emulsifying arrangement according to claim 6, wherein the planes are formed by stacked foils (16) which are provided with grooves or foil openings (17) forming flow guides.

8. The emulsifying arrangement according to claim 1, wherein in the emulsifying chamber (1) a core is arranged so as to extend over the full length so that the emulsifying chamber is in the form of an annular gap.

9. The emulsifying arrangement according to claim 1, wherein the emulsifying chamber (1) has a variable cross-section.

10. The emulsifying arrangement according to claim 1, wherein the emulsifying chamber (I) includes temperature control means.
